(19) United States
(12) Patent Application Publication
(10) Pub. No.: US 2025/0121578 A1
(43) Pub. Date: Apr. 17, 2025

(54) METHOD OF MAKING CORRUGATED LINER PRODUCT FOR A FOOD CONTAINER AND CUTTING DIE

(71) Applicants: Gregory ARVANIGIAN, Kalamazoo, MI (US); Kevin KELLOGG, Kalamazoo, MI (US)

(72) Inventors: Gregory ARVANIGIAN, Kalamazoo, MI (US); Kevin KELLOGG, Kalamazoo, MI (US)

(21) Appl. No.: 18/889,495

(22) Filed: Sep. 19, 2024

Related U.S. Application Data
(60) Provisional application No. 63/590,495, filed on Oct. 16, 2023.

(51) Int. Cl. B31F 1/22; B26F 1/38; B26F 1/44

(52) U.S. Cl. CPC B31F 1/225; B26F 1/384; B26F 1/44

(57) ABSTRACT

A method of manufacturing a corrugated liner for a food container using a rotary die cutting machine, and a die element for use with such a die cutting machine. The method includes feeding a planar blank of material between opposed die and anvil cylinders of the rotary die cutting machine, cutting and perforating each planar blank with the die cylinder, and forming a plurality of die-cut products each in sheet form and having a plurality of planar polygonal liners on each sheet. Immediately adjacent ones of the planar polygonal liners on each sheet are connected to one another along immediately adjacent and mating straight peripheral portions thereof by respective perforated connection areas. The method additionally includes ejecting each die-cut product sheet from the rotary die cutting machine, and the perforated connection areas of each sheet maintain the plurality of planar polygonal liners thereof in a connected state with one another.

### CROSS REFERENCE TO RELATED APPLICATION

This claims priority of U.S. Provisional Application No. 63/590,495, filed Oct. 16, 2023, the disclosure of which is hereby incorporated by reference in its entirety.

### TECHNICAL FIELD

This relates to a method of making a liner product for a food carrier or container, and to a cutting die for making such a liner product.

### BACKGROUND AND SUMMARY

Containers constructed from a single-sheet of material, such as corrugated cardboard, and folded into a box form for transporting food and other objects are well-known. Such boxes are commonly used for storing and transporting pizza, as well as other food items. With respect to corrugated containers used for pizza storage and transport, the container can easily become soggy due to absorption of pizza grease or other liquids, particularly on and/or around the bottom wall of the container on which the pizza is supported. This can cause structural deficiencies in the container, leaks and can also make the container unrecyclable due to the transfer of the grease and/or other liquids from the pizza to the container. In order to address these issues, a corrugated circular liner is placed inside the container on top of the bottom wall thereof, which liner serves to reinforce the bottom of the container and to absorb grease and liquid from the pizza. Such liners may also aid in heat retention.

The known corrugated circular liners discussed above are often manufactured using a rotary die cutting machine including opposed and rotating die and anvil cylinders. The die cylinder mounts a die element thereon and the die element incorporates cutting blades shaped and/or arranged in a manner which defines the desired shape of the end product. Such die elements are sometimes referred to as “die boards”. An example of such a die-cut product is shown in FIG. 5 and is discussed below. The die cut product includes a plurality, and solely as an example six are shown here, of circular liners arranged in two rows of three and three columns of two, providing a total of six liner products. During production, sheets of corrugated cardboard or blanks are fed into and between the die and anvil cylinders and in the process, the sheet is cut to form six circular liners. Due to the configuration and/or location of the cutting blades on the die element, small connection areas of corrugated material are formed between adjacent liner products (sometimes referred to as “gutter material”). When the cut corrugated sheet is released from the die cutting machine, the individual liner products easily separate from one another and scatter over the work area. The worker must then gather the individual liner products, stack the individual liner products with one another and then shrink wrap or otherwise fix the liner products together for transport to the customer. The necessity of gathering and arranging the individual liner products after the sheets are cut accordingly results in undesirable worker inefficiencies. Further, this process generates an unsatisfactory amount of material waste and dust, since the small amount of corrugated material which (temporarily) interconnects each of the adjacent circular liner products is expelled from the die cutting machine during processing of the corrugated sheet.

In order to improve on the known method of manufacturing corrugated liners as discussed above, the method according to one aspect of the invention avoids separation of the liner products from one another when the die-cut sheets are ejected from the rotary cutting machine. More specifically, the method forms die-cut products in sheet form with a die element that cuts the individual sheets in a manner that forms a plurality of planar liners, which liners are not in the conventional circular form, but instead are polygonal in shape and are therefore formed to have a series of straight edges which define the outer periphery of the liner. In one embodiment, the individual polygonal liners are arranged on the die-cut sheet in rows and columns, and immediately adjacent ones of the polygonal liners on the sheet are connected to one another along adjacent and mating straight peripheral portions by respective perforated connection areas. These perforated connection areas maintain the liners formed on each sheet in a connected state with one another after the cutting process, so that the liners do not separate when the sheet is ejected from the die cutting machine. The interconnected liners can thereafter be separated from one another in stacks, for example at a bending/breaking station.

### BRIEF DESCRIPTION OF THE DRAWINGS

FIG. 1 is a perspective view of part of a rotary die cutting die machine, and specifically illustrates a rotary cutting die apparatus having a die cylinder and an anvil cylinder;

FIG. 2 is an enlarged plan view of a die element in isolation, which in use is mounted on the die cylinder as shown in FIG. 1;

FIG. 3 is a plan view of a die-cut product in sheet form including a plurality of interconnected liner products, prior to separation of the liner products from one another;

FIG. 4 is an enlarged detail view of a connection area between two adjacent liner products as shown in FIG. 3;

FIG. 5 is a plan view of a prior art die-cut product including a plurality of liner products; and

FIG. 6 is a diagrammatic view of a method of making the liner product of FIG. 3.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the object being described and of designated parts thereof. Said terminology will include the words specifically mentioned, derivatives thereof, and words of similar import.

### DETAILED DESCRIPTION

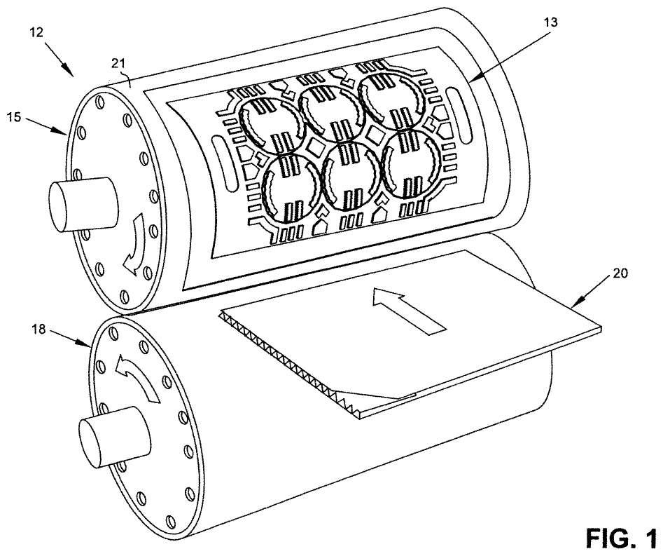

FIG. 1 illustrates part of a rotary die cutting machine 10 (shown diagrammatically in FIG. 6), and specifically a rotary die cutting apparatus 12. The rotary die cutting apparatus 12 includes a die element 13 secured to a die cylinder 15 and an anvil cylinder 18 disposed in opposed relation with the die cylinder 15. In use, the two cylinders 15 and 18 are rotated in opposite directions from one another (as indicated by the arrows in FIG. 1) and sheets or blanks of corrugated material 20, such as corrugated cardboard, are fed into and through the nip defined between the cylinders 15 and 18 and, in the process, the corrugated material 20 is cut to form a die-cut product in sheet form (discussed in detail below).

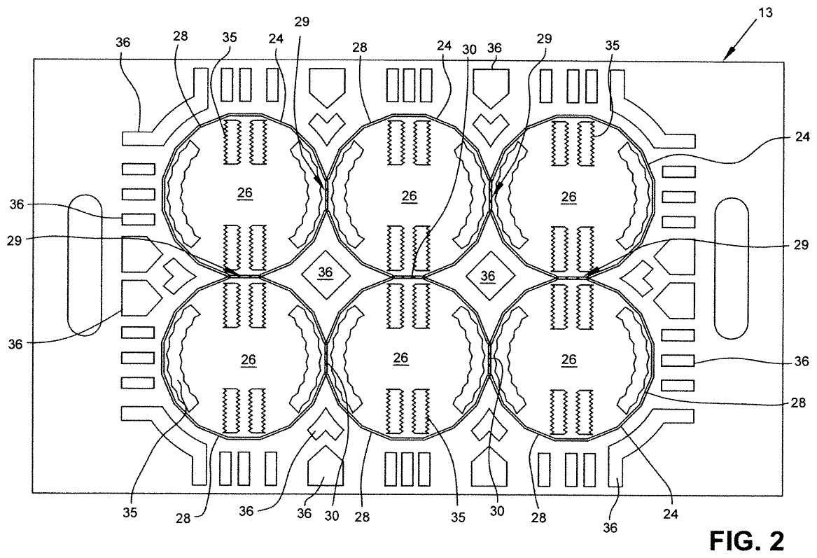

With reference to FIGS. 1 and 2, the die cylinder 15 has an outer surface 21 on which the die element 13 is mounted, and to permit this, the die element 13 has a curvature complementary to the curvature of the outer surface 21. The die element 13 mounts thereon a plurality of cutting blades 24, which cutting blades 24 are toothed or serrated and are configured and oriented on the die element 13 so as to cut completely through the thickness of the blank of corrugated material 20 as same passes between the cylinders 15 and 18. The cutting blades 24 function to cut and therefore define the overall dimensions of the die-cut product. In this regard, the cutting blades 24 are oriented on the outer surface 21 of the die element 13 so as to define a plurality, and solely as an example six are shown here, of polygonal areas 26 across the outer face of the die element 13.

In the embodiment of the die element 13 illustrated in FIG. 2, the cutting blades 24 which surround each polygonal area 26 include a series of straight blade segments or portions 28 arranged on the die element 13 so as to define the majority of an outer periphery of each polygonal area 26, except at one or more regions 29 located along each outer periphery. At each of these regions 29, the die element 13 mounts thereon a straight perforating blade or blade arrangement 30. In this embodiment, the polygonal areas 26 are arranged on the die element 13 in rows of three and columns of two (a “2λ3” arrangement). However, it will be appreciated that the arrangement will vary depending on the desired number of products to be produced from each blank of material 20, and thus the polygonal areas 26 can be arranged in 4×6 or 3λ6 configurations, for example. In the arrangement of FIG. 2, the two polygonal areas 26 located in the endmost columns are each positioned closely adjacent to two neighboring polygonal areas 26 and thus each of these polygonal areas 26 has part of its periphery defined by two of the regions 29, at each of which regions 29 one perforating blade 30 extends between adjacent and spaced-apart ones of the blade segments 28. Further, the two polygonal areas 26 located in the middle column in FIG. 2 are each positioned closely adjacent to three neighboring polygonal areas 26 and thus each of these middle polygonal areas 26 has its periphery partially defined by three of the regions 29, at each of which regions 29 one perforating blade 30 extends between adjacent and spaced-apart blade segments 28.

Each of the perforating blades 30 has a series of teeth spaced apart from one another by a greater distance as compared to the tooth spacing of the cutting blades 24 so as to create a plurality of perforated areas on the die-cut product, which perforated areas permit separation of the products from one another after the die-cut product is ejected from the rotary die cutting apparatus 12, as discussed further below.

With continued reference to FIG. 2, the die element 13 additionally includes various arrangements of strippers or product ejectors 35 and 36 which are mounted on the die element 13 and function to separate the die cut product therefrom. The product ejectors 35 are positioned inside each of the polygonal areas 26, generally along the inside of the cutting and perforating blades 24 and 30, and the product ejectors 36 are positioned outwardly of and in between the polygonal areas 26. Further, the project ejectors 35 and 36 extend outwardly (in a direction perpendicular to a tangent of the outer surface 21 of the die element 13) beyond the terminal edges of the teeth of the cutting and perforating blades 24 and 30 and are constructed of resilient material. As such, the ejectors 35 and 36 are compressed as the die-cut product passes through the nip defined between the die element 13 and the opposed anvil cylinder 18 and prevent the die-cut product from sticking to the cutting and perforating blades 24 and 30.

Referring back to FIG. 1, with the die cylinder 15 and the anvil cylinder 18 rotating in opposite directions from one another, the blank of corrugated material 20 is fed into the nip between the cylinders 15 and 18. In one embodiment, the distance between the cylinders 15 and 18 is approximately equal to the thickness of the material 20. The rotation of the cylinders 15 and 18 causes the material 20 to pass through the die cutting apparatus 12, and the ejectors 35 and 36 and the anvil cylinder 18 exert pressure on the material 20 to prevent shifting while the cutting and perforating blades 24 and 30 are piercing or entering the material 20 during the cutting operation. As the material 20 moves through the die cutting apparatus 12, the ejectors 35 and 36 are compressed and the cutting and perforating blades 24 and 30 are forced against the material 20. When the cutting and perforating blades 24 and 30 move out of the material 20, the ejectors 35 and 36 expand and prevent the die-cut product from adhering to the blades 24 and 30.

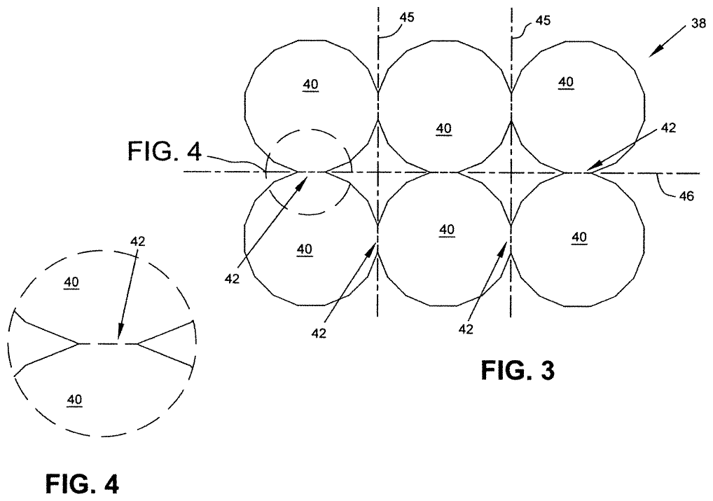

A die-cut product 38 resulting from the above-described cutting process is depicted in FIG. 3. As shown in FIG. 3, the configuration of the cutting and perforating blades 24 and 30 on the die element 13 results in a die-cut product 38 in sheet form including a plurality, and here six, of interconnected polygonal liners or liner products 40. The arrangement of the cutting blades 24 on the die element 13 defines the majority of the outer periphery of each liner product 40, while the perforating blades 30 form perforated connection areas 42 which serve to interconnect the liner products 40 to one another. In this embodiment, the individual polygonal liner products 40 each have a total of sixteen sides, and thus each is shaped as a hexidecagon. It will be appreciated that the number and/or length dimension of the individual sides provided on an individual polygonal liner product will vary based on the overall dimensions of the outer container in which the liner product will be used, and the above is presented only as an example of one such liner product. Thus, the configuration and/or arrangement of the blades 24 and 30 on the die element 13 would necessarily vary based on the desired size of the finished liner product.

In this configuration of the die-cut product 38, the two liner products 40 located in the two endmost columns are each interconnected to the two immediately adjacent liner products 40 by two perforated connection areas 42 which are spaced from one another along the outer periphery of each liner product 40. Further, the two liner products 40 located in the middle column are each connected to three neighboring liner products by three peripherally spaced-apart perforated connection areas 42. Thus, the die-cut product 38 in this embodiment includes a total of seven perforated connection areas 42. With continued reference to FIG. 3, the perforated connection areas 42 formed between the leftmost and middle columns of liner products 40, and the perforated connection areas 42 formed between the rightmost and middle columns of liner products 40, are respectively oriented along a linear bend or break line 45, with the two break lines 45 being parallel to one another. Further, the perforated connection areas 42 formed between the top row of liner products 40 and the bottom row of liner products 40 are located along a linear bend or break line 46 oriented perpendicular to and intersecting the break lines 45. It will be appreciated that the die-cut product 38 can have more or less rows (and/or more or less columns) of liner products 40 than that shown which would result in the formation of more or less break lines 45 and 46 than that shown in FIG. 3.

Significantly, the perforated connection areas 42 maintain the liner products 40 of the die-cut product 38 connected to one another until it is desirable to separate same into individual liner products 40. Thus, when the die-cut product 38 exits or is expelled from between the die and anvil cylinders 15 and 18, separation and scattering of individual liner products is avoided unlike in the conventional method described above. Additionally, the above-described method and configuration of the die element 13 avoids material waste and dust, since the corrugated material at the perforated connection areas 42 is maintained and forms an integral part of the die-cut product 38 instead of being expelled from the die cutting apparatus 12 as in the conventional method.

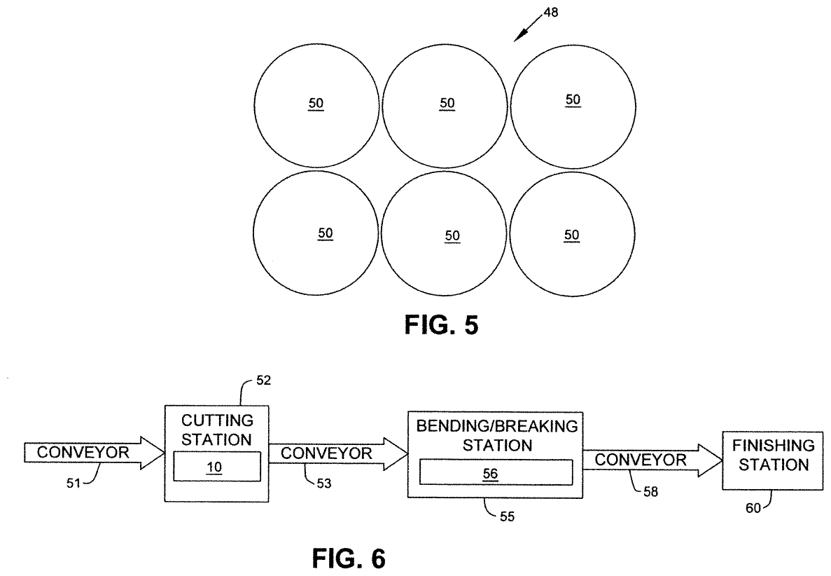

FIG. 5 is an illustration of a prior art die-cut product 48 which results from the conventional method and die element described herein. Specifically, the die-cut product 48 includes a plurality of circular liner products 50. Due to the configuration of the die element used (not illustrated, but which is evident from an examination of the die-cut product 48), only small connection areas of corrugated or gutter material are formed between adjacent liner products. These connection areas are insufficient to maintain the liner products 50 in an interconnected state after cutting of the blank and so the resulting die-cut product 48 produced by the conventional method is not a sheet product, but is, in actuality, six separate circular liner products 50 which, as described above, necessarily scatter as they exit the die cutting machine.

The method according to the invention will now be further described with reference to FIG. 6. A stack of individual sheets or blanks of corrugated material 20 are placed on a conveyor 51 and are transported to a cutting station 52. The cutting station 52 incorporates the rotary die-cutting machine 10 including the rotary die cutting apparatus 12 described above. The sheets of corrugated material 20 are fed individually into the rotary die cutting apparatus 12 and are cut by the die element 13 in the manner described above. The die-cutting machine 10 may incorporate a stacking device which stacks a predetermined number of the die-cut products 38 in sheet form, or a separate stacking machine located downstream of the die-cutting machine 10 may be used. In this regard, the stacking device arranges a predetermined number of individual die-cut products 38 in a vertical stack so that the bend/break lines 45 of each sheet product 38 are respectively aligned with the bend/break lines 45 of all other sheet products 38 of the stack, and so that the bend/break line 46 of each sheet product 38 is aligned with the bend/break line 46 of all other sheet products 38 of the stack. Each of the stacks of die-cut products 38 is then transported via a conveyor 53 to a bending/breaking station 55. The bending/breaking station 55 includes a bending/breaking machine 56 which bends each stack of die-cut products 38 along the bend/break lines 45 and/or 46, which effectively severs the connection areas 42 formed between adjacent liner products 40.

Whether the bending of the stack of die-cut products 38 is carried out along one, some or all of the aligned bend/break lines 45 and 46 of the stack depends on how the finished products are to be shipped to the customer. For example, if the predetermined number of die-cut products 38 in each stack is fifty, and if each of the stacks of die-cut products 38 is bent along both of the bend/break lines 45 and also along the bend/break lines 46 (with reference to the configuration of the die-cut product 38 illustrated in FIG. 3), this will result in six stacks of fifty individual liner products 40. The individual stacks of fifty individual liner products 40 are then transported to a finishing station 60 as shown in FIG. 6, where the stacks are secured for shipping to the customer. This may be achieved by shrink-wrapping each of the stacks or via another suitable method.

Alternatively, if each of the stacks of fifty die-cut products 38 is bent along only the bend/break lines 45, then this will result in three stacks with each of the three stacks including fifty sheets each having two interconnected liner products 40. The stacks are then secured at the finishing station 60, and the customer would separate the interconnected liner products 40 from one another.

As another alternative, if each of the stacks of fifty die-cut products 38 is bent along only the bend/break line 46, then this will result in two stacks with each of the two stacks including fifty sheets each having three interconnected liner products 40. As in the prior example, the customer would be responsible for separating the interconnected liner products 40 from one another.

One example of a suitable bending/breaking machine 56 is manufactured by the Geo. M. Martin Company and is sold under the trademark QUIK-BREAK™.

Although a particular preferred embodiment of the method, die element and liner product have been disclosed in detail for illustrative purposes, it will be recognized that variations or modifications, including the rearrangement of steps and/or parts, lie within the scope of the invention.

What is claimed is:

1. A method of manufacturing a corrugated liner for a food container using a die cutting machine having rotating and opposed die and anvil cylinders, the method comprising:
providing a plurality of planar blanks of corrugated material;
feeding each planar blank of corrugated material between the opposed die and anvil cylinders of the rotary die cutting machine;
cutting each planar blank of corrugated material with the die cylinder;
perforating each planar blank of corrugated material with the die cylinder;
forming a plurality of die-cut products each in sheet form and including a plurality of planar polygonal liners arranged in side-by-side relation with one another on each die-cut product sheet, with immediately adjacent ones of the planar polygonal liners on each die-cut product sheet being connected to one another along immediately adjacent and mating straight peripheral portions thereof by respective perforated connection areas; and
ejecting each die-cut product sheet from the rotary die cutting machine, the perforated connection areas of each die-cut product sheet maintaining the plurality of planar polygonal liners thereof in a connected state with one another.

2. The method of claim 1, further including providing the die cylinder with a die element, the die element mounting thereon cutting blades and perforating blades, the cutting blades being arranged on the die element so as to define portions of each a plurality of polygonal areas oriented in side-by-side relation with one another, the cutting blades being further arranged on the die element such that each polygonal area is located immediately adjacent at least two other polygonal areas, the cutting blade corresponding to each polygonal area including a plurality of substantially straight portions defining a majority of an outer periphery of the corresponding polygonal area except at at least two regions spaced-apart from one another along the outer periphery, each perforating blade being substantially straight and arranged on the die element at one of the spaced-apart regions of each outer periphery of each polygonal area such that part of the outer periphery of each polygonal area is defined by at least two of the perforating blades.

3. The method of claim 2, wherein the step of cutting each planar blank of corrugated material is carried out using the die element, and the cutting blades and the perforating blades are used to form outer peripheries of the respective planar polygonal liners of each die-cut product sheet and the perforating blades are used to form the perforated connection areas of each die-cut product sheet.

4. The method of claim 1, wherein the step of forming includes forming each die-cut product sheet so that some of the perforated connection areas on each die-cut product sheet are oriented relative to one another to form at least one first linear bend line and remaining ones of the perforated connection areas on each die-cut product sheet are oriented relative to one another to form at least one second linear bend line oriented perpendicularly to the at least one first linear bend line.

5. The method of claim 4, further including:
stacking a plurality of the die-cut product sheets to form a stack such that the at least one first linear bend lines of the die-cut product sheets are aligned with one another and such that the at least one second linear bend lines of the die-cut product sheets are aligned with one another; and
bending the stack of die-cut product sheets along the aligned at least one first bend lines or along the aligned at least one second linear bend lines to separate at least some of the planar polygonal liners on each die-cut product sheet from one another.

6. The method of claim 4, further including:
stacking a plurality of the die-cut product sheets to form a stack such that the at least one first linear bend lines of the die-cut product sheets are aligned with one another and such that the at least one second linear bend lines of the die-cut product sheets are aligned with one another; and
bending the stack of die-cut product sheets along both of the aligned at least one first bend lines and the aligned at least one second linear bend lines.

7. The method of claim 4, further including bending the stack of die-cut product sheets along the aligned at least one first bend lines and the aligned at least one second linear bend lines and forming at least two stacks of planar polygonal liners, such that each layer of each of the two stacks includes a single planar polygonal liner or a plurality of interconnected planar polygonal liners.

8. A method of manufacturing a corrugated liner for a food container using a die cutting machine having rotating and opposed die and anvil cylinders, the method comprising:
providing the die cylinder with a die element, the die element mounting thereon cutting blades and at least one perforating blade, the cutting blades being arranged on the die element so as to define portions of each a plurality of substantially identical polygonal areas oriented in side-by-side relation with one another, the cutting blades being further arranged on the die element such that each polygonal area is located immediately at least one other polygonal area, the cutting blade corresponding to each polygonal area including a plurality of substantially straight portions defining a majority of an outer periphery of the corresponding polygonal area except at at least one region on the die element, the at least one perforating blade being substantially straight and arranged on the die element at the at least one region of each outer periphery of each polygonal area such that part of the outer periphery of each polygonal area is defined by the at least one perforating blade;
providing a plurality of planar blanks of corrugated material;
feeding each planar blank of corrugated material between the opposed die and anvil cylinders of the rotary die cutting machine;
cutting each planar blank of corrugated material with the cutting blades of the die element;
perforating each planar blank of corrugated material with the at least one perforating blade of the die element; and
wherein the cutting and perforating steps form a plurality of die-cut products each in sheet form and including a plurality of planar polygonal liners arranged in side-by-side relation with one another with immediately adjacent ones of the planar polygonal liners being interconnected to one another along at least one straight perforated area formed by the at least one perforating blade during the perforating step.

9. The method of claim 8, wherein the step of providing comprises providing a die element with a plurality of perforating blades such that the outer periphery of each polygonal open area is defined by at least two of the perforating blades spaced-apart from one another along the outer periphery of each polygonal area, and the cutting and perforating steps form a plurality of die-cut products each in sheet form and including a plurality of planar polygonal liners arranged in side-by-side relation with one another with immediately adjacent ones of the planar polygonal liners being interconnected to one another along at least two straight perforated areas formed by the plurality of perforating blades during the perforating step.

10. The method of manufacturing of claim 8, wherein after the steps of cutting and perforating, the method further includes ejecting each die-cut product sheet from the rotary die cutting machine, the at least one straight perforated area of each die-cut product sheet maintaining the plurality of polygonal liners thereof in a connected state with one another.

11. The method of claim 9, wherein the step of perforating includes perforating each planar blank of corrugated material so that some of the straight perforated areas on each die-cut product sheet are oriented relative to one another to form at least one first linear bend line and remaining ones of the straight perforated areas on each die-cut product sheet are oriented relative to one another to form at least one second linear bend line oriented perpendicularly to the at least one first linear bend line.

12. The method of claim 11, further including:
stacking a plurality of the die-cut product sheets to form a stack such that the at least one first linear bend lines of the die-cut product sheets are aligned with one another in the stack and such that the at least one second linear bend lines of the die-cut product sheets are aligned with one another in the stack; and
bending the stack of die-cut product sheets along the aligned at least one first linear bend lines, or along the aligned at least one second linear bend lines, or along the aligned at least one first bend lines and the aligned at least one second linear bend lines to separate some or all of the planar polygonal liners on each die-cut product sheet from one another.

13. The method of claim 12, wherein the step of bending includes forming at least two stacks of planar polygonal liners, such that each layer of each of the two stacks includes a single planar polygonal liner or a plurality of planar polygonal liners connected to one another by perforated connection areas.

14. A die element for use with a die cylinder in a rotary die cutting machine, the die element mounting thereon cutting blades and perforating blades, the cutting blades being arranged on the die element so as to define portions of each of a plurality of substantially identical polygonal areas oriented relative to one another in side-by-side relation, the cutting blades being further arranged on the die element such that each polygonal area is located immediately adjacent at least two other polygonal areas, the cutting blade corresponding to each polygonal area including a plurality of substantially straight portions defining a substantial portion of an outer periphery of the corresponding polygonal area except at at least two regions spaced-apart from one another along the outer periphery, each perforating blade being substantially straight and arranged on the die element at one of the spaced-apart regions of each outer periphery of each polygonal area such that the outer periphery of each polygonal area is defined by at least two of the perforating blades.
